(19) United States
(12) Patent Application Publication
(10) Pub. No.: US 2014/0007621 A1
(43) Pub. Date: Jan. 9, 2014

(54) METHOD FOR MANUFACTURING A POLYSILICON INGOT

(71) Applicant: MOTECH INDUSTRIES INC., New Taipei City (TW)

(72) Inventors: Kai-An Ho, Taipei City (TW); Chien-Kang Chou, Tainan City (TW)

(73) Assignee: MOTECH INDUSTRIES INC., New Taipei City (TW)

(21) Appl. No.: 13/846,038

(22) Filed: Mar. 18, 2013

(30) Foreign Application Priority Data
Jul. 6, 2012 (TW) 101124418

(51) Int. Cl. C01B 33/021

(52) U.S. Cl. CPC C01B 33/021
USPC 65/95; 65/90

(57) ABSTRACT

A method for manufacturing a polysilicon ingot includes: (a) providing molten silicon in a container; (b) maintaining a surface temperature of the molten silicon higher than its melting point while decreasing the temperature of a base portion of the container to a temperature (T₁) lower than the melting point at a rate of at least 2.6° C./min; (c) increasing the temperature of the base portion to a temperature (T₂) lower than the melting point; (d) maintaining the surface temperature of the molten silicon higher than the melting point while decreasing and then increasing the temperature of the base portion to a temperature lower than the melting point of silicon; and (e) reducing the temperature of the molten silicon to form the polysilicon ingot.

### BACKGROUND OF THE INVENTION

1. Field of the Invention

This invention relates to a method for manufacturing a silicon ingot, more particularly to a method for manufacturing a polysilicon ingot.

2. Description of the Related Art

A Polysilicon wafer applied in a conventional polysilicon solar cell are typically formed by cutting a polysilicon ingot. The manufacture of the polysilicon ingot is carried out by heating a silicon material in a crucible to obtain molten silicon, which is then cooled down and allowed to condense so as to form the polysilicon ingot.

However, by simply cooling and condensing the molten silicon, the crystal properties of the resulting silicon ingot can hardly be controlled in an effective manner. The silicon ingot thus produced typically suffers from the problems of having small crystal grains and lots of grain boundaries. A solar cell comprising a silicon wafer cut from the aforementioned silicon ingot will have low open circuit voltage and low photoelectric conversion efficiency. Therefore, improvement in the manufacture of the polysilicon ingot is desired.

### SUMMARY OF THE INVENTION

Therefore, the object of the present invention is to provide a method for manufacturing a polysilicon ingot having large grains and good crystalline characteristics.

Accordingly, the present invention provides a method for manufacturing a polysilicon ingot, comprising:

(a) providing molten silicon in a container that has a base portion;

(b) maintaining a surface temperature of the molten silicon higher than the melting point of silicon while decreasing the temperature of the base portion of the container to a temperature (T₁) lower than the melting point of silicon at a rate of at least 2.6° C./min;

(c) after step (b), increasing the temperature of the base portion of the container to a temperature (T₂) lower than the melting point of silicon while maintaining the surface temperature of the molten silicon higher than the melting point of silicon;

(d) after step (c), maintaining the surface temperature of the molten silicon higher than the melting point of silicon while decreasing the temperature of the base portion of the container to a temperature lower than the melting point of silicon and then increasing the temperature of the base portion of the container to a temperature lower than the melting point of silicon; and

(e) reducing the temperature of the molten silicon to form the polysilicon ingot.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic view showing a container for use in the preferred embodiment of a method for manufacturing a polysilicon ingot according to the present invention;

FIG. 2 is a flow chart illustrating the preferred embodiment of the method according to the present invention;

FIG. 3 is a diagram showing the relationship between temperature and time during the process of the method according to the present invention;

FIG. 4 is a photograph of a polysilicon ingot produced by a conventional method; and

FIG. 5 is a photograph of a polysilicon ingot produced by the preferred embodiment according to the present invention.

### DETAILED DESCRIPTION OF THE PREFERRED EMBODIMENT

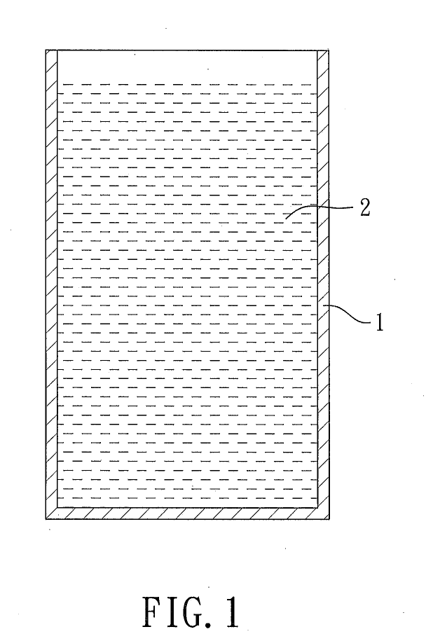

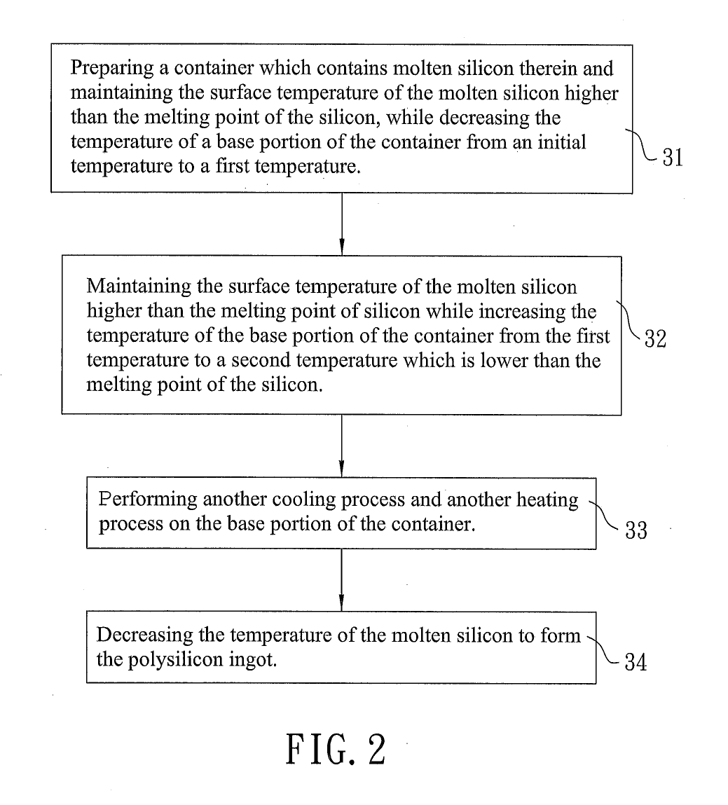

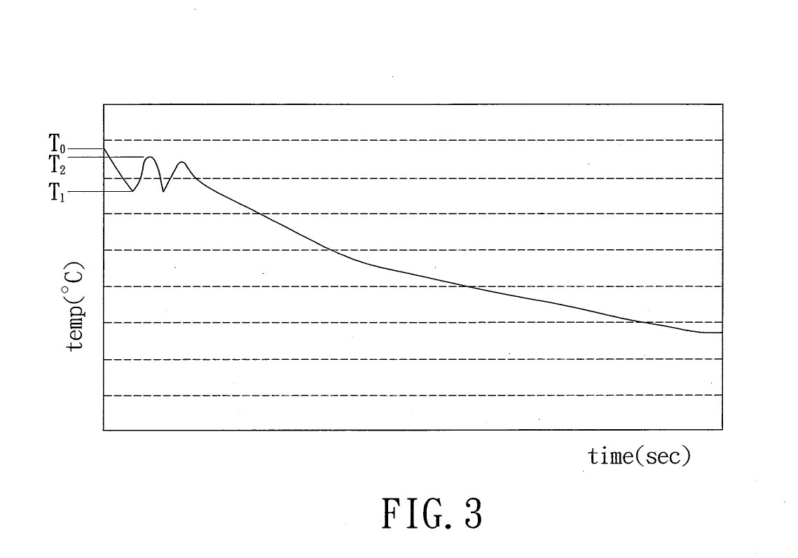

FIGS. 1, 2 and 3 show the preferred embodiment of a method for manufacturing a polysilicon ingot according to the present invention, which includes the following steps:

(1) Step 31: Preparing a container 1 which contains molten silicon 2 therein. A surface temperature of the molten silicon 2 is maintained to be higher than the melting point of the silicon, while the temperature of a base portion of. the container 1 is decreased from an initial temperature (T₀) to a first temperature (T₁) lower than the melting point of the silicon. In this step, the molten silicon 2 in the vicinity of the base portion 11 of the container 1 undergoes a first rapid cooling process which is the so-called super-cooling step, through which silicon with a twins-crystalline structure is grown. Densely distributed twins-crystalline structures will facilitate growing of a dendrite structure, which, in turn, results in a polysilicon ingot with larger grains and a better crystal quality.

Specifically, the container 1 may be a crucible. Decreasing the temperature of the base portion 11 of the container 1 is conducted by blowing a cold air flow toward the base portion 11 of the container 1. The initial temperature (T₀) of the base portion 11 of the container 1 must be higher than the melting point of silicon (about 1410° C.) so as to maintain the silicon material in the container 1 in a molten state. It is found that growing of the dendrite crystal structure is affected by the rate of cooling the molten silicon 2. A greater cooling rate will facilitate growing of the dendrite structure.

This step 31 serves as a base step to form a polysilicon base for the polysilicon ingot. The quality of the resulting polysilicon ingot product will be affected by the uniformity of the polysilicon base formed in this step.

The uniformity of the polysilicon base is, in turn, affected by the cooling rate. The cooling rate must be great enough in order to obtain a polysilicon base with satisfactory uniformity. Therefore, it is necessary that the first temperature (T₁) be limited to be below a predetermined temperature, preferably equal to or lower than 1280° C., more preferably equal to or lower than 1000° C. In the present embodiment, the first temperature (T₁) is 1260° C. The cooling rate in this step 31 for cooling the base portion 11 of the container 1 is preferably of at least 2.6° C./min, more preferably of at least 6° C./min.

(2) Step 32: maintaining the surface temperature of The molten silicon 2 higher than the melting point of silicon while increasing the temperature of the base portion 11 of the container 1 from the first temperature (T₁) to a second temperature (T₂) which is lower than the melting point of the silicon.

The purpose of conducting the heating step 32 is to remove unstable crystal grains and impurities that might be produced during the previous cooling step 31. This purpose cannot be achieved if T₂ is too low. However, if T₂ is too high, the twins-crystalline structures produced in step 31 might be melted again. It is therefore preferable that T₂ is of at least 1340° C. and lower than 1380° C.

(3) Step 33: performing another cooling process and another heating process on the base portion 11 of the container 1. In this manner, growing of the dendrite structure is enhanced through the repeated heating and cooling processes in this step 33 in combination with the preceding step 31 and step 32. In step 33, the cooling and heating processes can be performed several times. In practice; the surface temperature of the molten silicon 2 is maintained higher than the melting point of the silicon, while the base portion 11 of the container 1 is decreased from T₂ to a temperature which may be the same as or different from T₁ and which in the present embodiment is about 1260° C., the same as T₁. Subsequently, the base portion 11 of the container 1 is heated again to a temperature which is lower than the melting point of silicon and which, in the present embodiment, is about 1340° C. The temperatures described herein are for illustration only, and the invention should not be limited in this respect.

Likewise, the cooling rate in step 33 is preferably of at least 2.6° C./min, more preferably of at least 6° C./min, for the same purpose of enhancing growing of the dendrite structure.

(4) Step 34: decreasing the temperature of the molten silicon 2 by cooling the base portion 11 of the container 1. The molten silicon 2 is then solidified gradually from the base portion 11 of the container 1 to form the polysilicon ingot. An annealing reaction may be conducted during this cooling step so as to eliminate the inner stress of the polysilicon ingot. The annealing reaction is conducted at a temperature ranging from 1000° C. to 1300° C. for 3 hours.

In the present invention, by repeatedly varying the temperature of the silicon material, that is, by carrying out at least two rapid cooling steps and two heating steps, the polysilicon base would be formed with the dendrite crystal structure with larger grains. In this manner, the polysilicon ingot gradually formed in an upward direction from the polysilicon base will also have greater grains and a better crystal quality.

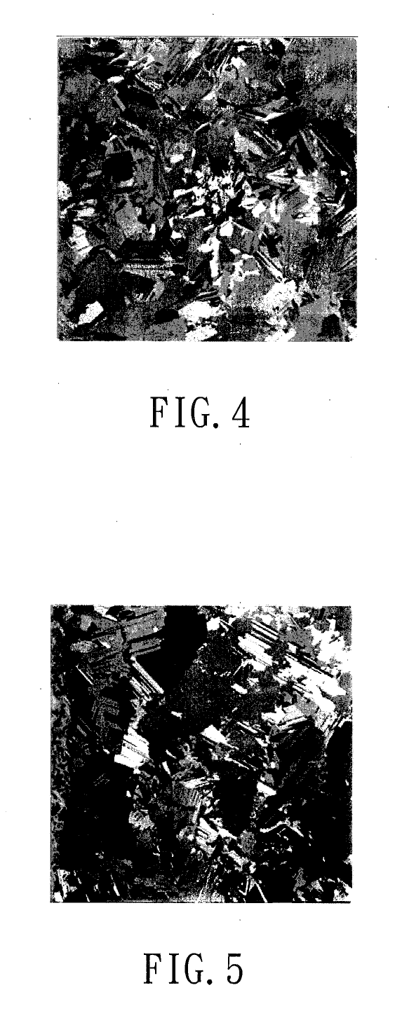

FIGS. 4 and 5 are photographs showing respectively a comparative polysilicon ingot produced by a conventional method and a polysilicon ingot produced in accordance with the method of the present invention. The comparative polysilicon ingot shown in FIG. 4 has smaller grains and a large number of grain boundaries, and the grains are randomly oriented. Moreover, sub-grains are found in the comparative polysilicon ingot. A solar cell which is installed with a solar panel formed from a crystal wafer cut from the comparative polysilicon ingot has a very low photoelectric conversion efficiency. On the other hand, in the present invention, the crystal growing is controlled by the repeated heating and cooling steps. The polysilicon ingot of the present invention has large grains, less grain boundaries, and good crystal quality, and thus exhibits enhanced photoelectric conversion efficiency.

According to a test result, a solar cell applied with a wafer cut from the comparative polysilicon ingot has a photoelectric conversion efficiency which is at most 17.12% and an open circuit voltage which is at most 0.624 Volt, while a solar cell applied with a chip cut from the polysilicon ingot produced by the method of the present invention has a photoelectric conversion efficiency of up to 17.47% and an open circuit voltage of up to 0.625 Volt.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A method for manufacturing a polysilicon ingot, comprising:
(a) providing molten silicon in a container that has a base portion;
(b) maintaining a surface temperature of the molten silicon higher than the melting point of silicon while decreasing the temperature of the base portion of the container to a temperature (T₁) lower than the melting point of silicon at a rate of at least 2.6° C./min;
(c) after step (b), increasing the temperature of the base portion of the container to a temperature (T₂) lower than the melting point of silicon while maintaining the surface temperature of the molten silicon higher than the melting point of silicon;
(d) after step (c), maintaining the surface temperature of the molten silicon higher than the melting point of silicon while decreasing the temperature of the base portion of the container to a temperature lower than the melting point of silicon and then increasing the temperature of the base portion of the container to a temperature lower than the melting point of silicon; and
(e) reducing the temperature of the molten silicon to form the polysilicon ingot.

2. The method of claim 1, wherein the rate of temperature increase in step (b) is at least 6.0° C./min.

3. The method of claim 1, wherein, in step (b), the temperature (T₁) is not greater. than 1280° C.

4. The method of claim 3, wherein, in step (b), the temperature (T₁) is not greater than 1000° C.

5. The method of claim 3, wherein, in step (c), the temperature (T₂) is between 1340° C. and 1380° C.

6. The method of claim 1, wherein, in step (d), the temperature of the base portion of the container is decreased at a rate of at least 2.6° C./min.

7. The method of claim 6, wherein, in step (d), the temperature of the base portion of the container is decreased at a rate of at least 6.0° C./min.

8. The method of claim 1, wherein, during step (e), an annealing reaction is conducted.

9. The method of claim 8, wherein the annealing reaction is conducted at a temperature ranging from 1000° C. to 1300° C. for 3 hours.

10. The method of claim 1, further comprising, before step (e), a step (f) of repeating step (d).
